(19) United States
(12) Patent Application Publication
(10) Pub. No.: US 2006/0038320 A1
(43) Pub. Date: Feb. 23, 2006

(54) Convertible boot system and method of making same

(76) Inventors: Martin L. Straub, Chelsea, MI (US); Michael J. Tokarz, Brownstown, MI (US)

Correspondence Address: HARNESS, DICKEY & PIERCE, P.L.C., P.O. BOX 828, BLOOMFIELD HILLS, MI, 48303, US

(21) Appl. No.: 10/920,145

(22) Filed: Aug. 17, 2004

(51) Int. Cl. B32B 37/00; B29C 65/00

(52) U.S. Cl. 264/265; 156/245; 156/285; 156/272.2; 156/381; 156/500; 264/496; 264/510; 264/553; 264/316; 264/328.1; 425/388

(57) ABSTRACT

The present invention is a 2-step molding process and a 1-step molding process that can be used to form a boot and/or tonneau cover for use in covering a convertible roof and/or a stowage compartment in an automotive vehicle. In the 1-step molding process, the boot and/or tonneau cover are formed by positioning the substrate material and other material layer(s) adjacent one another and forming the boot and/or tonneau cover in a mold in a single molding step. In a 2-step molding process, the substrate for the boot and/or tonneau cover is first formed in a mold. The formed substrate is then positioned adjacent material layer(s) and the formed substrate and material layer(s) are bound together within the same or a different mold in a subsequent molding step.

### BACKGROUND AND SUMMARY OF THE INVENTION

This invention generally relates to boot and tonneau covers for automotive vehicles and, more particularly, to methods of making boots and tonneau covers for covering convertible roof stowage compartments in automotive vehicles.

Most traditional convertible roof vehicles, either hardtop or soft-top, stow the convertible roof in a boot well or stowage compartment that is located aft of a passenger compartment in the vehicle. A boot or tonneau cover is then used to cover a portion or an entirety of the stowage compartment and conceal a portion or an entirety of a convertible roof from view and/or protect the stowed roof from the environment.

A boot is a generally semi-rigid cover that has some flexibility to allow it to be deformed and/or distorted when inserting and removing the boot over the stowage compartment. For example, a typical boot will have clips or other appendages that fit with complementary recesses or features around the stowage compartment to allow the boot to remain in place during operation of the automotive vehicle. Additionally, the boot may also have hinges (i.e., living hinges and fabric hinges) or be capable of being folded upon itself for convenient storage when the convertible roof is in a raised position. In contrast, a tonneau cover is a substantially rigid structure that is not deformed and/or distorted during opening and closing to allow extension and retraction of the convertible roof. Additionally, the tonneau cover is also not folded upon itself.

A typical compression molded boot is made from a laminate structure having an intermediate foam material layer impregnated with a resin, an outer or exterior material layer and, optionally, an inner or interior material layer. The laminate structure is placed in a closed mold, pressed together and heated for a prescribed period of time. The resin hardens and binds the various layers of the laminate structure together. The mold is then opened and the boot formed therein is removed. The resin that is used to harden and bind the various layers of the boot together is expensive. Thus, if the use of the expensive resin material can be avoided, a lower cost and more economical boot can be formed.

A typical tonneau cover is made by molding a rigid substrate into a desired form or shape in a closed mold. For example, the rigid structure that forms a tonneau can be injection molded or compression molded. After forming the rigid substrate a finish layer or decorative layer can be applied to the rigid substrate to provide a desired finish. The finish layer is applied by the use of an adhesive. The adhesive is sprayed on or mechanically applied to the panel and the finish material is then positioned on the panel in contact with the adhesive layer to bind the finish material to the rigid substrate. The application of the adhesive to the panel, however, is an extra processing step that can increase the time required to manufacture a finished tonneau cover. Additionally, the adhesive may not be uniformly applied and/or experience uniform contact with the finish material so that the two become unbonded or separated at a later time. Thus, if the separate step of applying an adhesive layer to the substrate can be avoided, a reduction in the manufacturing time may be possible.

Additionally, because the boot and tonneau cover are typically made in a closed mold, the mold includes multiple parts that must be manufactured to provide the desired shape. These mold parts, however, are expensive to produce. Thus, if a boot and/or tonneau cover could be formed in an open mold wherein only one molding surface is utilized, a less expensive and more economical boot and/or tonneau cover can be manufactured. Additionally, the use of an open mold provides additional molding capabilities such as undercutting that is not possible in a closed mold. Thus, an open mold can be more economical and provide additional flexibility in the manufacturing of a desired shape and form for a boot and/or tonneau cover.

In accordance with the present invention, a tonneau cover is created by forming a substantially rigid substrate into a desired shape in a mold and attaching a material layer having an adhesive thereon to the formed substrate with the adhesive. The rigid substrate can be formed in an open mold and, optionally, the same mold can be used to position the material layer in a desired position in the rigid substrate. The present invention for manufacturing a tonneau cover is advantageous over the manufacture of traditional tonneau covers in that the tonneau cover can be manufactured without utilizing the additional step of applying an adhesive layer to the rigid substrate.

In accordance with another aspect of the present invention, a boot is manufactured by forming a semi-rigid substrate into a desired shape in a mold and attaching a material layer to one side of the formed substrate with an adhesive. In accordance with yet another aspect of the present invention, the boot is formed by positioning a sheet of substrate material between mold components, positioning a finish material adjacent the substrate material and forming a boot from the sheet of substrate material and the finish material into a desired shape in the mold.

The methods of forming the boot are advantageous over traditional manufacturing techniques in that the boots so formed do not rely upon expensive resins to form the semi-rigid structure. By using substrate material that can be formed into a rigid shape, the cost of producing such boots is reduced. Additionally, the boot can be formed in an open or closed mold thereby providing the opportunity of producing the boot with a less expensive mold and allowing for an undercut of the boot to be formed. Additional advantages and features of the present invention will become apparent from the following description and appended claims taken in conjunction with the accompanying drawings.

### BRIEF DESCRIPTION OF THE DRAWINGS

The present invention will become more fully understood from the detailed description and the accompanying drawings, wherein:

FIGS. 1A and B are perspective views of a boot and tonneau cover, respectively, manufactured according to the principles of the present invention;

FIGS. 2A and B are cross-sectional views of the boot and tonneau cover of FIGS. 1A and B along lines 2A-2A and 2B-2B, respectively;

FIG. 3 is a perspective view of an open mold with a formed substrate and material layers that can be used according to the principles of the present invention to form a boot or tonneau cover;

FIG. 4 is a perspective view of a closed mold in an open position with a formed substrate and material layers that can be used to form a boot or tonneau cover according to the principles of the present invention; and

FIG. 5 is a simplified flow chart of the two-step method of forming a boot and/or tonneau cover according to the principles of the present invention;

FIG. 6 is a simplified chart of the one-step method of forming a boot and/or tonneau cover according to the principles of the present invention; and

FIGS. 7A and 7B are perspective views of an automotive vehicle having the respective boot and tonneau cover of FIGS. 1A and 1B covering a portion of a stowage compartment and the convertible roof therein.

### DETAILED DESCRIPTION OF THE PREFERRED EMBODIMENT

The following description of the preferred embodiment is merely exemplary in nature and is in no way intended to limit the invention, its application, or uses.

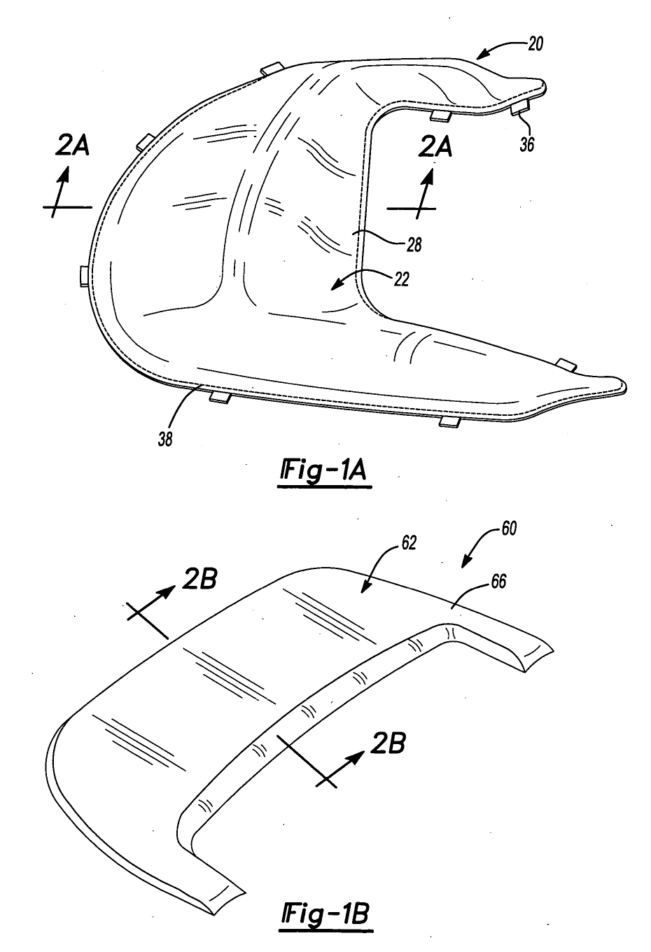

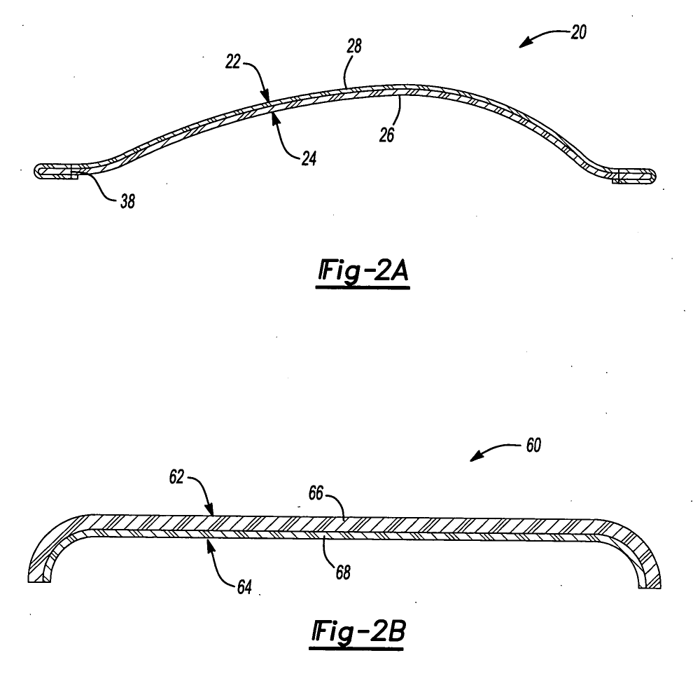

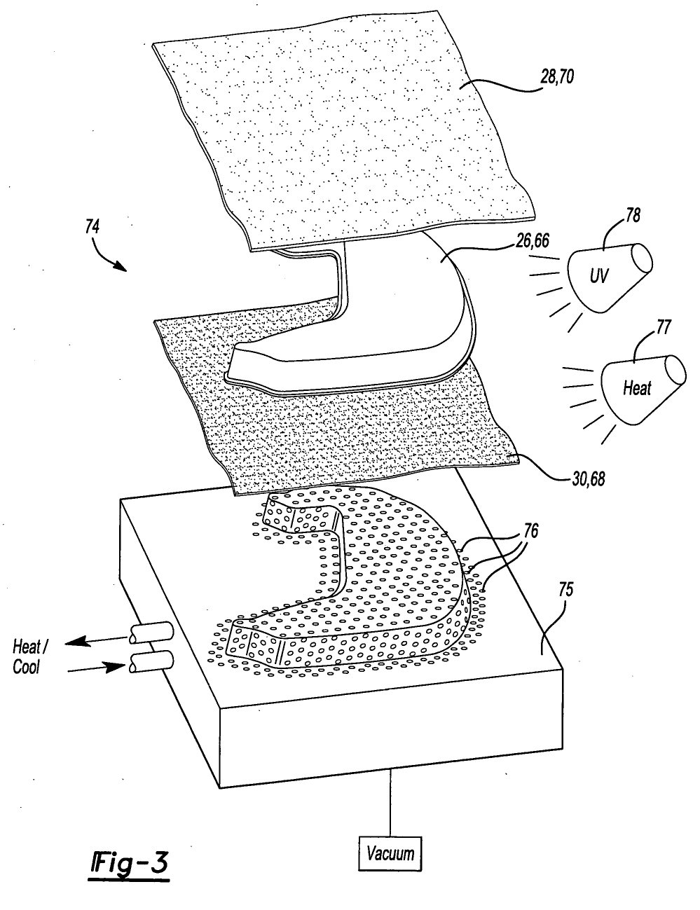

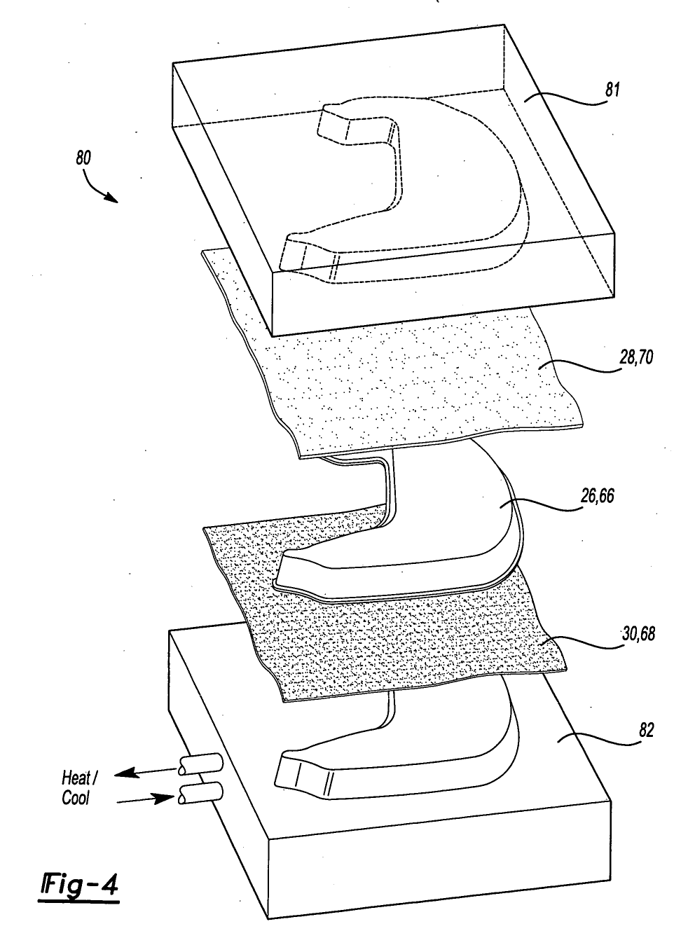

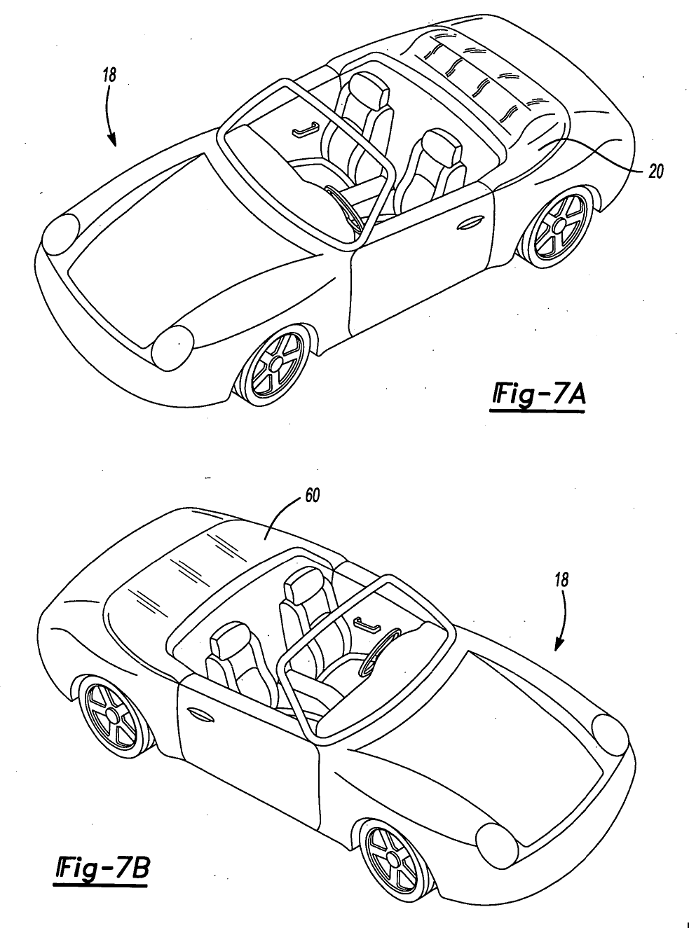

The present invention provide for methods of manufacturing boots and tonneau covers for use in covering a convertible roof stowage compartment of an automotive vehicle 18, such as shown in FIGS. 7A and 7B. Referring to FIGS. 1A and 2A, there is shown a boot 20 manufactured according to the principles of the present invention. Boot 20 has an outer surface 22 which forms an exterior portion of boot 20 and an inner surface 24 which faces the automotive vehicle upon which boot 20 is utilized. Boot 20 is formed with a semi-rigid substrate 26. An exterior material layer 28, such as vinyl, leather, cloth, carbon fiber and decorative appliques, is on the exterior side of semi-rigid substrate 26 and forms the outer surface 22 of boot 20. Optionally, an interior material layer or scrim 30 (shown in FIGS. 3 and 4 only), such as a light weight fabric, can be attached to an interior surface of semi-rigid substrate 26 to thereby form inner surface 24 of boot 20.

Optionally, boot 20 can have one or more tabs 36 that extend along a periphery of boot 20. Tabs 36 are designed to facilitate the retaining of boot 20 in a desired position covering the stowage compartment of an automotive vehicle. Additionally, depending on the level of adhesion of exterior material layer 28 to semi-rigid substrate 26, and also depending upon the desired appearance, exterior material layer can be folded over along the edge of semi-rigid substrate 26 and bound thereto with stitching, such as stitches 38.

A boot 20 so formed with a semi-rigid substrate 26 is capable of being deformed and/or distorted during the installation and removal process from vehicle 18 and, due to its resilient nature, returns to its desired shape. Additionally, boot 20 may have hinges, such as living hinges or fabric hinges (not shown), that facilitate the folding of boot 20 upon itself for convenient storage when the convertible roof is in an upright position and/or the boot 20 is not needed or desired to be used to cover the stowage compartment. The process of manufacturing boot 20 is described in more detail below.

Referring now to FIGS. 1B and 2B, a tonneau cover 60 manufactured according to the principles of the present invention is shown. Tonneau cover 60 is a substantially rigid structure that allows a limited degree of deformation, such as slight bending or flexing, when being used on automotive vehicle 18. Tonneau cover 60 has an outer surface 62 that forms an exterior surface of an automotive vehicle upon which it is utilized. Tonneau cover 60 also has an inner surface 64 that forms an interior surface and faces the stowage compartment of the automotive vehicle. Tonneau cover 60, as shown in FIG. 2B, includes a rigid substrate 66 and an interior material layer 68, such as vinyl, leather, carbon fiber, brushed aluminum and decorative applique, attached to the inner side of rigid substrate 66 and forms inner surface 64 of tonneau cover 60. Optionally, an exterior material layer, such as vinyl, leather, carbon fiber, brushed aluminum and decorative applique, (shown in FIGS. 3 and 4 only) can be attached to the outer surface of rigid substrate 66 and forms the outer surface of 62 of tonneau cover 60.

Tonneau cover 60 is used to cover a portion (partial or entirety) of a stowage compartment of automotive vehicle 18. Tonneau cover 60 is designed to be moved between an open position allowing retraction and extension of a convertible roof into/out of the stowage compartment, and a closed position covering at least a portion (partial or entirety) of the stowage compartment. The operation of tonneau cover 60 from a closed to an open position can be a manual operation or an automatic operation. For example, the tonneau cover can be attached to a mechanism, such as that disclosed in U.S. Pat. No. 6,659,534, entitled “Hard-top Convertible Roof System” which issued to Willard on Dec. 9, 2003, the disclosure of which is incorporated herein by reference, which automatically enables tonneau cover 60 to be moved between the open and closed positions. As stated above, tonneau cover 60 is a rigid structure, due to rigid substrate 66, that allows a limited amount of deformation when moving between the open and closed positions. Tonneau cover 60 is not deigned to be folded upon itself nor to undergo substantial deformation during its operation. The manufacturing process, according to the principles of the present invention by which tonneau cover 60 is made is described below.

Referring now to FIG. 3, an open mold 74 which can be used to form boot 20 and/or tonneau cover 60 is shown. Open mold 74 is a simplistic representation of a typical open mold that is used in a vacuum molding process. Open mold 74 includes a mold plate 75 that has a surface contour that is to be imparted to the boot 20 and/or tonneau cover 60 formed thereon. Mold plate 75, shown in FIG. 3, is a male mold plate wherein the contoured surface extends outwardly from the mold plate 75. Alternatively, a female mold plate (not shown) wherein the desired contour to be imparted to the boot 20 and/or tonneau cover 60 is recessed into the mold plate can also be used. Mold plate 75 has a plurality of small openings spaced along the contoured surface to allow a vacuum to be pulled therethrough. The vacuum is pulled through the openings 76 and will cause the substrate material and/or material layer(s) to be pulled or sucked down against the contoured surface of mold plate 75. Mold plate 75 can be heated and/or cooled to cause the substrate material to be formed into the configuration imparted by the contoured surface. Mold plate 75 can be heated in a variety of ways. For example, mold plate 75 can be heated electrically or by passing a fluid, such as heated water, through internal flow channels within mold plate 75. With the use of flow channels, heat can also be removed from the mold plate 75 by providing a coolant flow therethrough. Alternatively and/or additionally, heat can also be applied to the substrate material and material layer(s) via an external heat source such as heat lamp 77.

Open mold 74 can be used to form the substrate material into the desired shape prior to applying material layer(s) thereto and/or to apply the material layer(s) to a pre-formed substrate in a 2-step molding process discussed below. Alternatively, open mold 74 can be used to form the substrate material and material layer(s) into a desired shape and bond the material layer(s) thereto in a 1-step molding process discussed below. Open mold 74 can also include a UV radiation source 78 to apply UV radiation to the material layer(s) and substrate material to activate a UV radiation activated adhesive, as discussed in more detail below.

To use open mold 74, a vacuum is applied to the substrate and material layer(s) via openings 76. When open mold 74 is used to form a single piece of material into the desired shape, such as semi-rigid substrate 26 or rigid substrate 66, the material used does not need to be vacuum permeable. Rather, the material needs to be vacuum impermeable so that the vacuum applied by open mold 74 causes the material to be sucked or pulled down against the contour of mold plate 75. When more than one layer are to be pulled against mold plate 75, however, only the outermost layer on the mold plate 75 can be vacuum impermeable while the other layers must allow a vacuum to be pulled therethrough (vacuum permeable). In other words, when making a three layer boot and/or tonneau cover within open mold 74, as shown in FIG. 3, both the innermost material layer 30, 68 and the formed substrate 26, 66 need to be vacuum permeable in order to pull exterior material layer 28, 70, substrate 26, 66 and interior material layer 30, 68 snugly against one another and against mold plate 75 so that the layers take the contour of mold plate 75. Thus, all of the interior and middle layers that are used to form a boot 20 and/or tonneau cover 60 must be vacuum permeable to use open mold 74.

Referring now to FIG. 4, a closed mold 80 which can be used to form boot 20 and/or tonneau cover 60 in either the 2-step molding process or 1-step molding process according to the principles of the present invention is shown. Closed mold 80 includes an upper mold component 81 and a lower mold component 82. Upper and lower mold components 81, 82 can be moved from an open position wherein they are spaced apart to a closed position wherein they are adjacent and form a mold cavity therebetween. In the closed mold 80 shown in FIG. 4, the lower mold component 82 has a contoured surface that extends outwardly therefrom and is received in a contoured recess surface in upper mold 81. The external and recessed contoured surfaces are configured to provide a desired shape for a boot 20 and/or tonneau cover 60 to be formed therein. Like the open mold 74, heat can be added to the materials within the mold cavity via electrical heating and/or the application of a heated fluid to flow channels within upper and/or lower mold components 81, 82. Additionally, heat can be removed from the components within closed mold 80 by flowing a coolant through the fluid channels in upper and/or lower mold components 81, 82.

Closed mold 80 can be used to form semi-rigid and/or rigid substrates 26, 66 for use in the 2-step molding process discussed below. Closed mold 80 can also be used to compress the material layer(s) and formed substrate together in the 2-step molding process discussed below. Furthermore, closed mold 80 can also be used to simultaneously form a substrate material into the desired shape and bind the desired material layer(s) together in the 1-step molding process discussed below.

To use closed mold 80, the desired substrate material either individually or in conjunction with material layer(s) can be positioned between mold components 81 and 82. Mold components 81 and 82 are then moved to a closed position and compress the substrate material and material layer(s) together therein to impart the shape of the mold cavity onto the substrate material and material layer(s). Once the substrate material has been formed into the desired shape and/or the material layer(s) have been bonded to the substrate material, closed mold 80 is then opened by moving upper and lower mold components 81, 82 apart and the formed substrate and/or formed boot 20 and/or tonneau cover 60 can be removed therefrom.

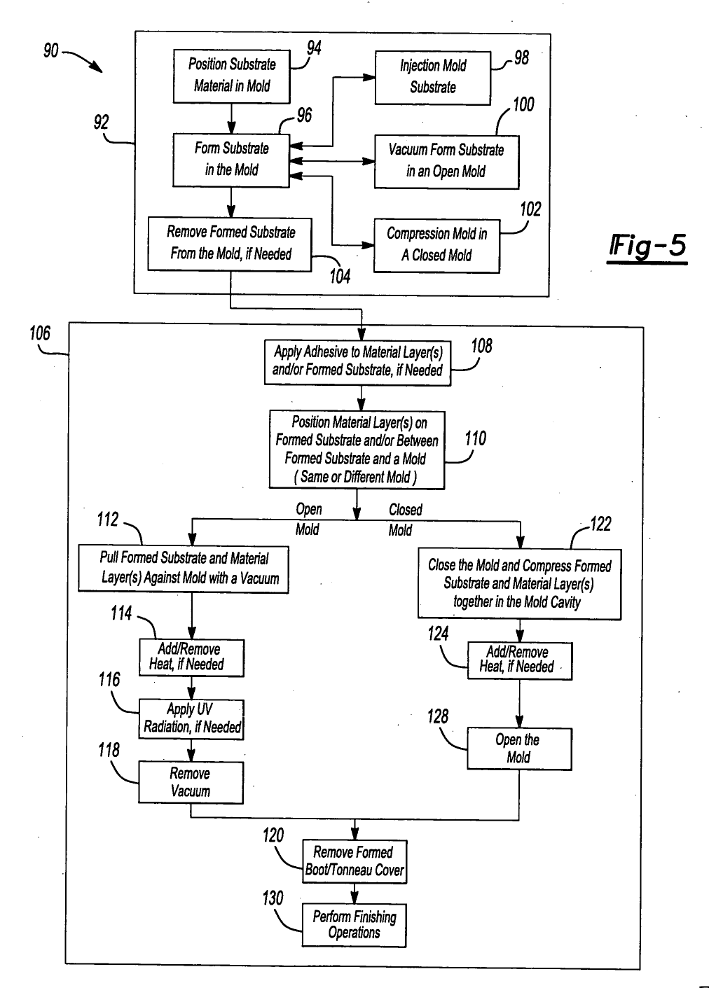

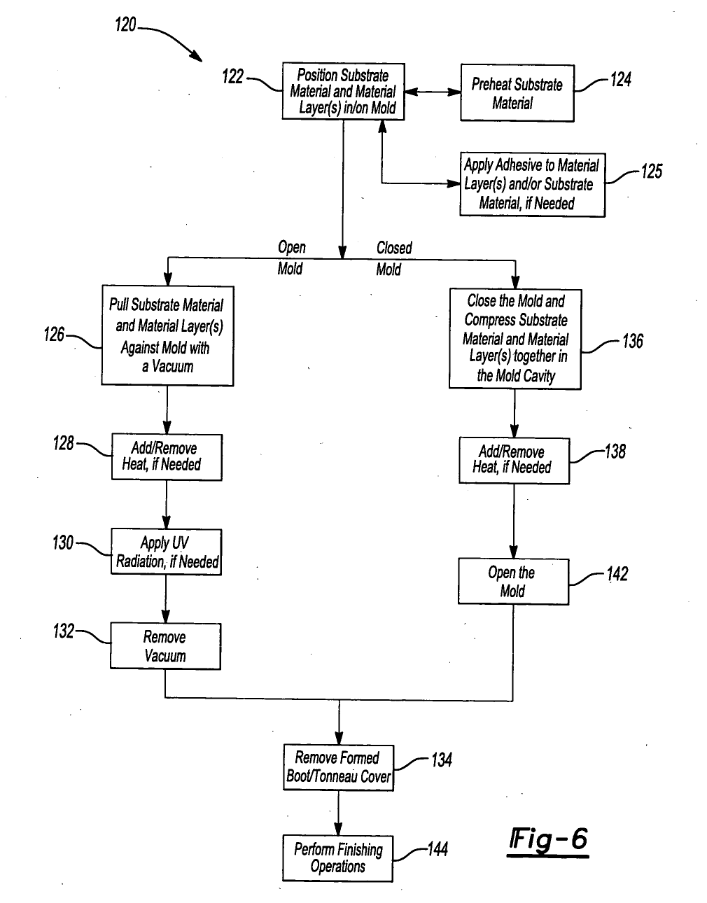

The present invention discloses the manufacturing of a boot 20 and/or tonneau cover 60 in both a 2-step molding process, such as that shown in FIG. 5, or alternatively, in a 1-step molding process, such as that shown in FIG. 6. Both the 2-step molding process and 1-step molding process can use an open mold, such as that shown in FIG. 3, or a closed mold, such as that shown in FIG. 4, to produce a boot 20 and/or tonneau cover 60.

Referring now to FIG. 5, the preferred 2-step molding process for manufacturing boot 20 and/or tonneau cover 60 is shown and generally indicated as 90. The first step in the 2-step molding process 90 is the formation of the substrate (either semi-rigid or rigid), as indicated in block 92. To form the substrate, the substrate material is positioned in the mold, as indicated in block 94 and then formed into the desired shape in the mold, as indicated in block 96. The material from which the substrate is formed will vary depending upon the desired characteristics of boot 20 and/or tonneau cover 60 and whether a boot 20 or tonneau cover 60 is being formed. Specifically, when forming a boot 20, the substrate material and dimensions are chosen so that the substrate formed therein is semi-rigid and allows for the flexible characteristics associated with boot 20, as described above. For example, semi-rigid substrate 26 for boot 20 can be formed from polypropylene, ABS polymer and/or other thermal formable polymers. The thickness of the semi-rigid substrate 26 is selected so that the substrate is deformable to allow easy removal and insertion of boot 20. Additionally, hinges, such a living hinges can be formed in the semi-rigid substrate 26 to allow the boot 20 formed therewith to be folded upon itself. When a tonneau cover 60 is being produced the substrate material is chosen and the dimensions are set such that a rigid substrate 66 is formed that has the rigid characteristics of tonneau cover 60 discussed above. The rigid substrate 66 for tonneau cover 60 can be formed from a polypropylene, an ABS polymer or other types of thermal formable polymers. The thickness dimension of the rigid substrate 66 formed to produce a tonneau cover 60 is selected so that the tonneau cover 60 formed therewith has the stiffness characteristics that are desired to prevent the tonneau cover 60 from significant deformation during operation of the tonneau cover.

The forming of the substrate in the mold can be done by a variety of different molding methods. For example, as indicated in block 98, a substrate can be formed by injection molding the substrate material in an injection molding assembly (not shown). Additionally, the substrate can be vacuum formed, as indicated in block 100, in an open mold such as that shown in FIG. 3, or can be compression molded, as indicated in block 102, in a closed mold, such as that shown in FIG. 4. Once the substrate has been formed in the mold, the substrate can be removed from the mold, as indicated in block 104, if needed. The substrate will be removed from the mold if a different mold is going to be used in the second step of the 2-step molding process 90. For example, it may be possible to use the open mold or closed mold shown in FIGS. 3 and 4 to perform the second step of the 2-step molding process 90. If an injection molding process is used, however, the substrate formed therein will need to be removed from the injection mold assembly prior to performing the second step of the 2-step molding process 90.

The second step of the 2-step molding process 90, is the addition of material layer(s) (exterior and/or interior) to the formed substrate, as indicated in block 106. To add the material layer(s), adhesive is applied to the material layer(s) and/or the formed substrate, as indicated in block 108. The necessity of applying an adhesive to the- material layer(s) and/or the formed substrate will depend upon whether the material layer(s) already has an adhesive therein or thereon and whether it is desired to have the adhesive on the material layer(s) or the formed substrate. If the material layer(s) already has an adhesive thereon or therein, the step indicated at block 108 is skipped. However, if an adhesive layer is needed, the adhesive can be applied to one or more of the material layer(s) and/or to the surface of the formed substrate to which the material layer is to be attached. The next step is to position the material layer(s) on the formed substrate and/or between the formed substrate and a mold component, as indicated in block 110. The exact position of the material layer(s) relative to the formed substrate will vary depending upon whether the material layer(s) is to be an exterior material layer or an interior material layer. In either case, the material layer(s) is positioned in the appropriate location relative to the formed substrate and relative to the mold that is to be used.

When an open mold, such as that shown in FIG. 3, is used, the formed substrate and material layer(s) are positioned in the appropriate locations and a vacuum is applied to the mold to suck or pull the material layer(s) and substrate together on the open mold, as indicated in block 112. As stated above, when using the open mold and the vacuum process, the material layer(s) or substrate that is in contact with the open mold and all intermediate layers must be capable of allowing a vacuum to be pulled therethrough (vacuum permeable) to allow the next material layer(s) and/or substrate to be pulled or sucked down snugly. For example, when the formed substrate is positioned on top of the open mold and the material layer(s) is an exterior layer, the formed substrate must allow a vacuum to be pulled therethrough (vacuum permeable) to suck not only the formed substrate against the mold but also to suck or pull the material layer(s) snugly along the surface of the formed substrate. Likewise, when a material layer(s) is positioned between the open mold and the formed substrate, the material layer(s) must allow a vacuum to be pulled therethrough (vacuum permeable) to suck or pull the substrate down firmly on top of the material layer(s) and the mold. The substrate and material layer(s) can be vacuum permeable by using a porous or micro-porous material or by making micro perforations in a non-porous material

With the substrate and material layer(s) snug against one another via the vacuum, depending upon the type of adhesive that is used, different activating steps will occur to activate the adhesive. For example, if the adhesive is a heat activated adhesive, heat is added to the material layer(s) and substrate, as indicated in block 114. Heat can be added to the material and substrate by heating the open mold or applying an external source of heat to the substrate and material layer(s) on the open mold, as indicated in block 114. Alternatively, if the adhesive is activated by ultraviolet radiation, ultraviolet radiation is applied to the adhesive through the material layer(s) and/or formed substrate, as indicated in block 116. A UV radiation activated adhesive, however, can only be used where UV radiation can reach the adhesive layer. For example, when a material layer(s) that is UV translucent is used, a UV activated adhesive can be used and the UV radiation transmitted through the material layer(s) to activate the adhesive layer. Thus, the material layer(s) and substrate are now attached together via the adhesive layer. With the substrate and material layer(s) attached together, the vacuum applied to the substrate and material layer(s) by the open mold can then be removed, as indicated in block 118. The formed boot/tonneau cover can then be removed from the open mold, as indicated in block 120.

When a closed mold is used instead of the open mold, the material layer(s) and formed substrate are positioned in the closed mold and compressed together by closing the mold, as indicated in block 122. Heat can then be added to the substrate and material layer(s), when a heat activated adhesive is used, to activate the adhesive and bond the material layers and formed substrate together, as indicated in block 124. When the material layer(s) and formed substrate are securely affixed to one another, the mold is opened, as indicated in block 128 and the formed boot/tonneau cover is then removed, as indicated in block 120.

With the formed boot/tonneau cover removed from the mold, the finishing operations to the formed boot/tonneau cover can then occur, as indicated in block 130. The finishing operations include such things as cutting or trimming excess material layer(s) and/or the formed substrate to the finalized dimensions, wrapping the edge of the material layer(s) around the edge of the substrate and sewing the edge to provide a desired appearance.

Thus, a boot and/or tonneau cover can-be formed using the 2-step molding process 90 avoiding the use of expensive resins in forming the substrate. The avoidance of these expensive resins reduces the cost of producing the boot and/or tonneau cover. The 2-step molding process also provides an efficient way to manufacture a boot 20 and/or tonneau cover 60. Additionally, by having the adhesive in the material layer(s), the time required to apply an adhesive can be avoided.

In an alternate embodiment, a 1-step molding process is used to form the boot 20 and/or tonneau cover 60. The 1-step molding process, generally indicated as 120, is illustrated in FIG. 6. The 1-step molding process 120 begins with positioning a substrate material, such as a sheet of substrate material, and one or more material layer(s) in/on a mold, as indicated in block 122. The type of substrate material and the thickness of the substrate material will be chosen based upon whether a boot 20 or a tonneau cover 60 is to be formed and the properties desired for the boot 20 and tonneau cover 60. For example, as stated above with reference to the 2-step molding process, the type of material and thickness is selected so that when a boot 20 is desired to be formed the substrate 26 is semi-rigid and allows for flexibility and deformation of the boot 20 when installing and removing the boot. When a tonneau cover 60 is to be produced, the type of material and thickness is chosen so that a substrate 66 is rigid and limited deformation of the tonneau cover 60 occurs. The types of material used for the substrate material in the 1-step molding process 120 are the same as those discussed above with reference to the 2-step molding process 90. Additionally, in the 1-step molding process 120, other materials can also be used. For example, a virgin polymer mixed with a combination of recycled/reground polymer, paper fibers and/or chipped wood can be used as the substrate material in the 1-step molding process 120. When the virgin polymer mix is used, the sheet is preheated to a near molten state, as indicated in block 124, prior to molding the substrate material and the material layer(s) into the desired shape. The virgin polymer mix contains internal binders that will bind the material layer(s) thereto when being formed into the desired shape in the mold, as described below. Additionally, as mentioned above with reference to block 108 of the 2-step molding process 90 and as indicated in block 125, an adhesive, such as a heat or UV radiation activated adhesive, can be applied to the material layer(s) and/or the substrate material. Alternatively, the material layer(s) can have an adhesive already thereon and the step in block 125 avoided. With the substrate material and the material layer(s) positioned in their desired orientation within/on the mold, the molding process is then begun.

When an open mold is used, such as that shown in FIG. 3, a vacuum is applied to the mold to pull the substrate material and the material layer(s) against the mold, as indicated in block 126. As stated above with reference to the 2-step molding process 90 when using an open mold, the substrate material and/or material layer(s) must be vacuum permeable to allow a vacuum to be pulled therethrough to pull or suck all of the components of the boot 20 or tonneau cover 60 being formed therein snugly against one another on the open mold. Again, this can be accomplished by using a porous or microporous material or by forming micro perforations in a non-porous material. With the substrate material and material layer(s) firmly snugged against one another, the adhesive that is used to bind the substrate material and material layer(s) together can then be activated. When a heat activated adhesive is used, heat is added to the adhesive layer via the mold and/or the application of heat external to the mold, as indicated in block 128. When a UV radiation activated adhesive is used, UV radiation is applied to the adhesive, as indicated in block 130. As stated above with reference to the 2-step molding process 90, when a UV radiation activated adhesive is used, the material layer(s) must be UV translucent to allow the UV radiation to reach the adhesive. When the virgin polymer mix is used no adhesive is necessary as the material already contains binders that will bind the material layer(s) to the material and heat is removed to cool the material from its molten state so that is solidifies and takes the shape of the open mold. With the substrate material and material layer(s) secured together, the vacuum is then removed from the open mold, as indicated in block 132, and the boot/tonneau cover formed therein is removed, as indicated in block 134.

When a closed mold is used, such as the closed mold shown in FIG. 4, the mold is closed and the substrate material and material layer(s) are compressed together therein, as indicated in block 136. Depending upon the type of adhesive used to bond the substrate material and material layer(s) together, heat can be added to or removed from the substrate material and material layer(s) therein, as indicated in block 138. For example, when a heat activated adhesive is used, heat is added to the substrate material and/or material layer(s) via the closed mold so the adhesive can be activated. When the virgin polymer mix is used, however, heat is removed from the material to allow the material to solidify and form the desired shape imposed by the mold cavity of the closed mold. Once the substrate material and material layer(s) are bonded together and formed into the desired shape, the mold is then opened, as indicated in block 142, and the boot/tonneau cover formed therein is removed from the mold, as indicated in block 134.

With the formed boot/tonneau cover removed from the mold, the finishing operations are then performed, as indicated in block 144. As stated above with reference to the 2-step molding process 90, the finishing operations include trimming the substrate material and/or material layer(s) to have a desired shape. Additionally, the finishing operations may included the wrapping of the material layer(s) over the edge of the substrate material and stitching along the periphery to provide a desired appearance. A boot 20 and/or tonneau cover 60 formed using the 1-step molding process 120 provides for the efficient manufacture of the boot/tonneau cover in a single molding operation. Additionally, the use of expensive resins to provide a desired rigidity to the substrate material is avoided. A boot 20 and/or tonneau cover 60 can thereby be economically formed by use of the 1-step molding process 120.

While the methods of the present invention have been disclosed and discussed with the use of specific materials to form a substrate, it should be appreciated that the materials disclosed are merely exemplary and that other materials exhibiting similar properties can also be used with the methods disclosed. Thus, the description of the invention is merely exemplary in nature and variations that do not depart from the gist of the invention are intended to be within the scope of the invention. Such variations are not to be regarded as a departure from the spirit and scope of the invention.

What is claimed is:

1. A method of manufacturing a tonneau cover for a convertible roof stowage area of an automotive vehicle, the tonneau cover including a substantially rigid substrate, a material layer, and an adhesive, the method comprising:
(a) shaping the substantially rigid substrate in a mold that results in the substrate having a desired shape;
(b) placing the adhesive on the material layer, the adhesive being of the type that is activated by at least one of heat and UV radiation;
(c) positioning the material layer having the adhesive thereon on the shaped substrate; and
(d) activating the adhesive.

2. The method of claim 1, wherein (a) includes molding the substrate from a thermoplastic material.

3. The method of claim 2, wherein (a) includes molding the substrate from polypropylene.

4. The method of claim 1, wherein (a) includes molding the substrate from a vacuum permeable substrate material and (c) includes positioning the substrate and the material layer on an open mold and pulling a vacuum on the material layer through the vacuum permeable substrate.

5. The method of claim 4, wherein (a) includes molding the substrate from a perforated sheet of substrate material and (c) includes pulling a vacuum on the material layer through perforations in the substrate.

6. The method of claim 1, wherein (c) includes positioning the substrate and the material layer in a mold and compressing the substrate and the material layer together in said mold.

7. The method of claim 6, wherein (c) includes compressing the substrate and the material layer together in said mold used to form the substrate.

8. The method of claim 1, wherein (a) includes injection molding the substrate.

9. The method of claim 1, wherein (c) includes positioning the material layer to an inner surface of the substrate.

10. A method of manufacturing a boot for a convertible roof stowage area of an automotive vehicle, the boot including a semi-rigid substrate, a material layer, and an adhesive, the method comprising:
(a) shaping the semi-rigid substrate in a mold that results in the substrate having a desired shape; and
(b) attaching the material layer to the formed substrate with the adhesive.

11. The method of claim 10, wherein (a) includes molding the substrate from a thermoplastic material.

12. The method of claim 11, wherein (a) includes molding the substrate from polypropylene.

13. The method of claim 10, wherein (a) includes molding the substrate from a vacuum permeable substrate material and (b) includes positioning the substrate and the material layer on an open mold and pulling a vacuum on the material layer through the vacuum permeable substrate.

14. The method of claim 13, wherein (a) includes molding the substrate from a perforated sheet of substrate material and (b) includes pulling a vacuum on the material layer through perforations in the substrate.

15. The method of claim 10, wherein (b) includes positioning the substrate and the material layer in a mold and compressing the substrate and the material layer together in said mold.

16. The method of claim 15, wherein (b) includes compressing the substrate and the material layer together in said mold used to form the substrate.

17. The method of claim 10, wherein (b) includes attaching the material layer to an outer surface of the substrate.

18. The method of claim 10, wherein (b) includes attaching a material layer having the adhesive layer thereon to the substrate with the adhesive layer.

19. The method of claim 10, wherein (b) includes attaching the material layer to the substrate with an adhesive that is activated by at least one of heat and UV radiation.

20. A method of forming a boot for a convertible roof stowage area of an automotive vehicle, the boot including a semi-rigid substrate, a material layer, and an adhesive, the method comprising:
(a) positioning a sheet of substrate material in a mold;
(b) positioning a finish material layer adjacent said substrate material; and
(c) forming the boot from said sheet of substrate material and said finish material layer in said mold that results in the boot having a desired shape.

21. The method of claim 20, wherein (a) includes positioning a sheet of virgin polymer mixed with at least one of recycled/reground polymer, paper fibers and chipped wood substrate material in said mold.

22. The method of claim 21, further comprising preheating said substrate material to a near molten state prior to performing (b) and wherein (c) includes cooling said substrate material.

23. The method of claim 20, wherein said mold is an open mold, said substrate material is vacuum permeable, and (c) includes pulling a vacuum on said finish material through said vacuum permeable substrate.

24. The method of claim 23, wherein (c) includes heating said substrate material in said mold.

25. The method of claim 20, wherein said substrate material is a foam backed material.

26. The method of claim 20, wherein (a) includes positioning a sheet of thermoplastic substrate material in said mold.

27. The method of claim 20, wherein (a) includes positioning a sheet of polyethylene substrate material in said mold.

28. The method of claim 20, wherein said mold is a closed mold having at least two parts operable to join together and form a mold cavity and (c) includes compressing said sheet of substrate material and said finish material together in said mold cavity.

29. The method of claim 20, wherein (a) includes applying an adhesive layer to said sheet of substrate material and (c) includes bonding said finish material to said substrate with the adhesive during the forming of said boot.

30. The method of claim 20, wherein (b) includes applying the adhesive layer to said finish material and (c) includes bonding said finish material to said substrate with the adhesive during the forming of the boot.

31. A system for manufacturing a boot and a tonneau cover for a convertible roof stowage area of an automotive vehicle, the system comprising:
a mold having a contoured portion corresponding to a desired shape;
a substrate material operable to be shaped in said mold into said desired shape;
at least one material layer operable to be positioned on said substrate material to form at least a portion of one of an inner and outer surface; and
an adhesive operable to bind said material layer to said substrate.

32. The system of claim 31, wherein said mold is a closed mold and includes at least two mold components operable to form a mold cavity when positioned together, said mold cavity imparting said desired shape on said substrate material and compressing said substrate material and said material layer together within said mold cavity when positioned together.

33. The system of claim 31, wherein said mold is an open mold having a plurality of openings therein and through which a vacuum is created to pull said substrate material and said material layer together on said open mold.

34. The system of claim 31, wherein said adhesive is heat activated and further comprising a heat source operable to heat said adhesive thereby activating said adhesive.

35. The system of claim 31, wherein said adhesive is UV radiation activated and further comprising a UV radiation source operable to irradiate said adhesive with UV radiation thereby activating said adhesive.

36. The system of claim 31, wherein said substrate material is a thermoplastic.

37. The system of claim 31, wherein said substrate material is polyethylene.

38. The system of claim 31, wherein said substrate material is semi-rigid when shaped in said mold.

39. The system of claim 31, wherein said substrate material is rigid when shaped in said mold.
